(19) United States
(12) Patent Application Publication
(10) Pub. No.: US 2009/0077665 A1
(43) Pub. Date: Mar. 19, 2009

(54) METHOD AND APPLICATIONS FOR DETECTING COMPUTER VIRUSES

(75) Inventor: Yi-Wen Chang, Taiwan (CN)

Correspondence Address: GREENBLUM & BERNSTEIN, P.L.C., 1950 ROLAND CLARKE PLACE, RESTON, VA, 20191, US

(73) Assignee: MATSUSHITA ELECTRIC INDUSTRIAL CO., LTD., Osaka (JP)

(21) Appl. No.: 11/909,292

(22) PCT Filed: Mar. 20, 2006
(86) PCT No.: PCT/JP2006/306045

§ 371 Date: Sep. 21, 2007

(30) Foreign Application Priority Data
Mar. 22, 2005 (CN) 200510059066.9

(51) Int. Cl. G06F 21/00

(52) U.S. Cl. 726/24

(57) ABSTRACT

A method for detecting computer viruses includes the following steps: (a) enabling a server device to make statistics of computer virus infection record of a mobile terminal and infection record of all computer viruses in a network so as to obtain infection number rankings of viruses that infected the mobile terminal and all computer viruses in the network, respectively; (b) enabling the server device to generate virus pattern data according to infection number ranking results of the viruses that infected the mobile terminal and all computer viruses in the network; (c) enabling the server device to transmit the virus pattern data to the mobile terminal; (d) enabling the mobile terminal to receive data via the network; and (e) enabling the mobile terminal to detect whether the data is infected by a computer virus with reference to the virus pattern data, and to transmit computer virus infection information to the server device upon detection that the data is infected by a computer virus.

### TECHNICAL FIELD

The invention relates to a method for detecting computer viruses and applications thereof, more particularly to a method for detecting whether data received by a mobile terminal is infected by a computer virus and to applications thereof.

### BACKGROUND ART

With networking connectivity becoming widespread, large quantities of files and programs are exchanged and shared among trusted or un-trusted network nodes via networks (such as the Internet), which result in an increase in computer virus infection or malicious attacks. Therefore, how to cope with these threats has long been an important issue in data networking environments.

However, when anti-virus efforts are conducted on mobile communications terminals, such as mobile phones, personal digital assistants (PDA), etc., a serious problem always comes up. That is, since the memory or storage capacity and the computing power of a central processing unit (CPU) are far less than those of a personal computer or the like, it is not possible to store all known virus pattern data for comprehensive virus detection and to compare all known virus pattern data with every application program and data. To cope with this problem, a common solution is to leave all virus pattern data at a server side so as to alleviate the burden of storage by mobile communications terminals, and to upload questionable files that need virus detection. Nevertheless, this solution unavoidably introduces communications overhead, which is aggravated if mobile communications terminals and server devices are connected by a wireless link having limited bandwidth.

To solve the aforementioned problems, it has been proposed in U.S. Patent Application Publication Number 20030157930A1, entitled “Server device, mobile communications terminal, information transmitting system and information transmitting method”, that server devices extract specific virus pattern data from a plurality of virus pattern data with reference to mobile terminal information, and transmit the customized virus pattern data to a mobile communications terminal for virus detection. The mobile terminal information may include hardware information (such as phone model or memory capacity), software information (such as operating system), information of application programs stored in the mobile communications terminal, history of data reception by the mobile communications terminal, or user requirements. This prior art can be used to accelerate virus detection on mobile communications terminals because the file size of the customized virus pattern data is usually relatively small. In addition, this prior art has a mechanism for warning mobile communications terminals when the number of times that some virus is detected exceeds a predetermined number (threshold), which enables mobile communications terminals to issue new virus detection requests.

Nonetheless, the aforesaid prior art has the following drawback. The server device provides specific virus pattern data only based on individual mobile terminal information. When extracting specific virus pattern data, virus infection situations of individual mobile communications terminals and the whole networking environment are not taken into consideration at the same time.

### DISCLOSURE OF INVENTION

Therefore, the object of the present invention is to provide a method for detecting computer viruses, which not only is adapted for accelerating virus detection operations on mobile terminals with limited memory or storage capacity and CPU computing power, but also takes into consideration virus infection situations of individual mobile terminals and the whole networking environment at the same time.

According to one aspect of the present invention, a method for detecting computer viruses comprises the following steps. First, a server device makes statistics of computer virus infection record of a mobile terminal and infection record of all computer viruses in a network, respectively, so as to obtain infection number rankings of viruses that infected the mobile terminal and all computer viruses in the network, respectively. Next, the server device generates virus pattern data according to infection number ranking results of the viruses that infected the mobile terminal and all computer viruses in the network. The server device then transmits the virus pattern data to the mobile terminal via the network. Next, the mobile terminal receives data via the network. Thereafter, the mobile terminal detects whether the data is infected by a computer virus with reference to the virus pattern data, and transmits computer virus infection information to the server device upon detection that the data is infected by a computer virus.

Another object of this invention is to provide a mobile terminal that, in spite of having limited memory or storage capacity and CPU computing power, not only can accelerate virus detection operations, but also takes into consideration virus infection situations of individual mobile terminals and the whole networking environment at the same time during the process of virus detection.

According to another aspect of the present invention, a mobile terminal is adapted for detecting, with assistance from a server device, whether data received via a network is infected by a computer virus. The mobile terminal comprises a virus infection information database, a virus pattern database, a transceiver unit, a virus pattern updating unit, a virus detecting unit, and an infection information notifying and storing unit. The virus infection information database is used to store computer virus infection information. The virus pattern database is used to record virus pattern data. The transceiver unit is used to send the computer virus infection information to the server device and to receive the data via the network. The virus pattern updating unit is used to update the virus pattern data stored in the virus pattern database. The virus detecting unit is used to detect whether the data received by the transceiver unit is infected by a computer virus with reference to the virus pattern data stored in the virus pattern database. The infection information notifying and storing unit is used to notify the server device that the data received by the transceiver unit is infected by a computer virus according to a virus detection result received from the virus detecting unit, and to record the computer virus infection information in the virus infection information database.

Yet another object of this invention is to provide a server device which not only is adapted for accelerating virus detection operations on mobile terminals with limited memory or storage capacity and CPU computing power, but also takes into consideration virus infection situations of individual mobile terminals and the whole networking environment at the same time.

According to yet another aspect of the present invention, a server device is adapted for assisting a mobile terminal via a network to detect whether data received via the network is infected by a computer virus. The server device comprises a virus infection information database, a virus pattern database, a statistics unit, a ratio determining unit, a virus pattern generating unit, a transceiver unit, and a virus detecting unit. The virus infection information database is used to store computer virus infection information of the mobile terminal and infection information of all computer viruses in the network. The virus pattern database is used to record virus pattern data of all computer viruses in the network. The statistics unit is used to make statistics of computer virus infection record of the mobile terminal and infection record of all computer viruses in the network as found in the virus infection information database so as to obtain infection number rankings of the viruses that infected the mobile terminal and all computer viruses in the network. The ratio determining unit is used to determine a ratio of a number of kinds of the computer viruses that had infected the mobile terminal to a number of kinds of the computer viruses that had infected the network for subsequent generation of virus pattern data according to the infection number rankings of the viruses that infected the mobile terminal and all computer viruses in the network as determined by the statistics unit. The virus pattern generating unit is used to generate the virus pattern data according to the ratio determined by the ratio determining unit, wherein the virus pattern data is to be transmitted to the mobile terminal for subsequent use by the mobile terminal in detecting whether the data received via the network is infected by a computer virus. The transceiver unit is used to send and receive the computer virus infection information and the data, and to send the virus pattern data to the mobile terminal. The virus detecting unit is used to detect whether data transmitted from the mobile terminal is infected by a computer virus with reference to the virus pattern data of all computer viruses as recorded in the virus pattern database, and to store the computer virus infection information in the virus infection information database.

### BRIEF DESCRIPTION OF DRAWINGS

Other features and advantages of the present invention will become apparent in the following detailed description of the preferred embodiment with reference to the accompanying drawings, of which:

FIG. 1 is a block diagram illustrating the preferred embodiment of a mobile terminal according to the present invention;

FIG. 2 is a block diagram illustrating the preferred embodiment of a server device according to the present invention;

FIG. 3 is a flowchart illustrating the preferred embodiment of a method for detecting computer viruses according to the present invention;

FIG. 4 is a data table for illustrating virus pattern data recorded in the mobile terminal according to the present invention;

FIG. 5 is a data table for illustrating another virus pattern data recorded in the mobile terminal of the present invention after being updated through the method for detecting computer viruses according to the present invention;

FIG. 6 is a data table for illustrating virus infection record of the mobile terminal according to the present invention;

FIG. 7 is a data table for illustrating results of statistics made by the server device of computer virus infection record of the mobile terminal and infection record of all computer viruses in the network;

FIG. 8 is a data table for illustrating one part of criteria used in the preferred embodiment of the method for detecting computer viruses according to the present invention;

FIG. 9 is a data table for illustrating another part of the criteria used in the preferred embodiment of the method for detecting computer viruses according to the present invention; and

FIG. 10 is a data table for illustrating updated criteria used in the preferred embodiment of the method for detecting computer viruses according to the present invention.

### BEST MODE FOR CARRYING OUT THE INVENTION

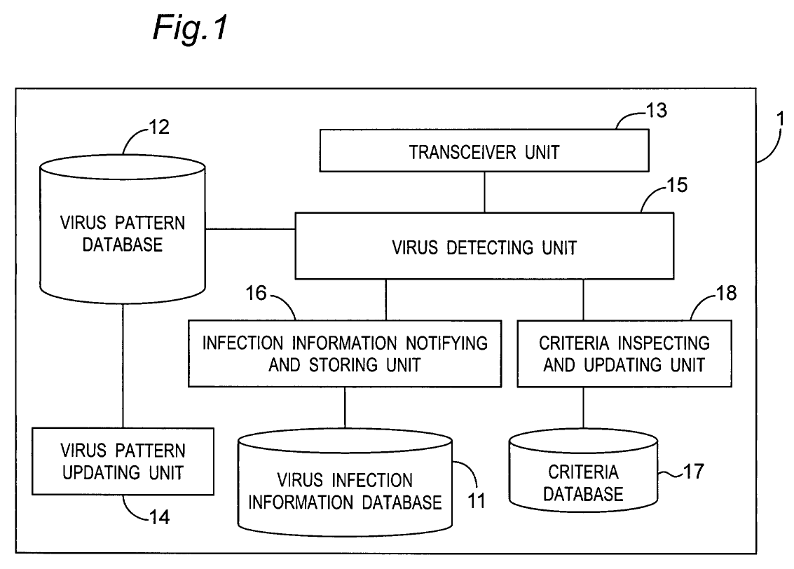

Referring to FIG. 1, the method and applications for detecting computer viruses of this invention are adapted for detecting whether data received by a mobile terminal 1 (such as a mobile phone) with limited memory or storage capacity and CPU computing power via a network (such as a mobile communications network, not shown) is infected by a computer virus. Not only can virus detection operations of the mobile terminal 1 be accelerated, virus infection situations of individual mobile terminals 1 and the whole networking environment are also taken into consideration at the same time.

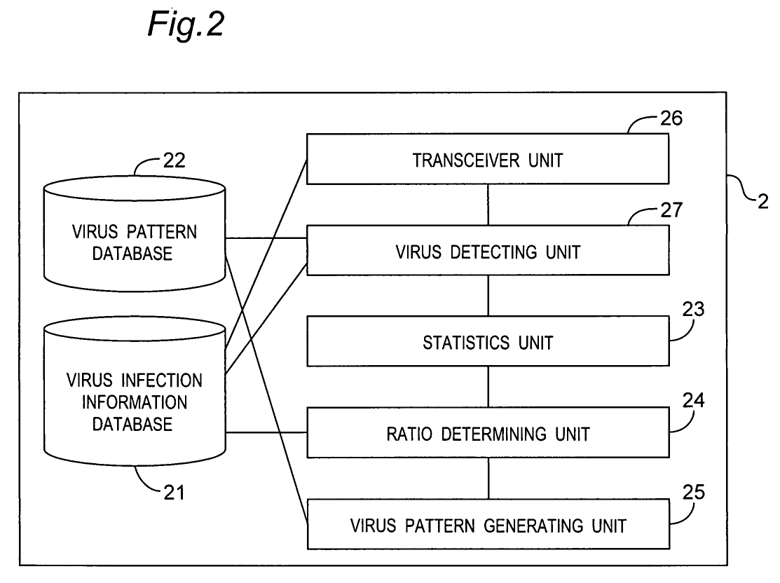

As shown in FIG. 1, the preferred embodiment of a mobile terminal 1, which applies the method for detecting computer viruses of this invention, is assisted by a server device 2 (see FIG. 2) to detect whether data received via the network is infected by a computer virus. The mobile terminal 1 includes a virus infection information database 11, a virus pattern database 12, a transceiver unit 13, a virus pattern updating unit 14, a virus detecting unit 15, an infection information notifying and storing unit 16, a criteria database 17, and a criteria inspecting and updating unit 18.

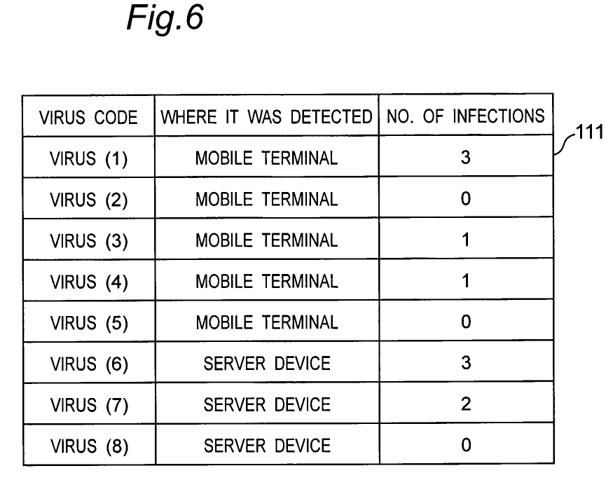

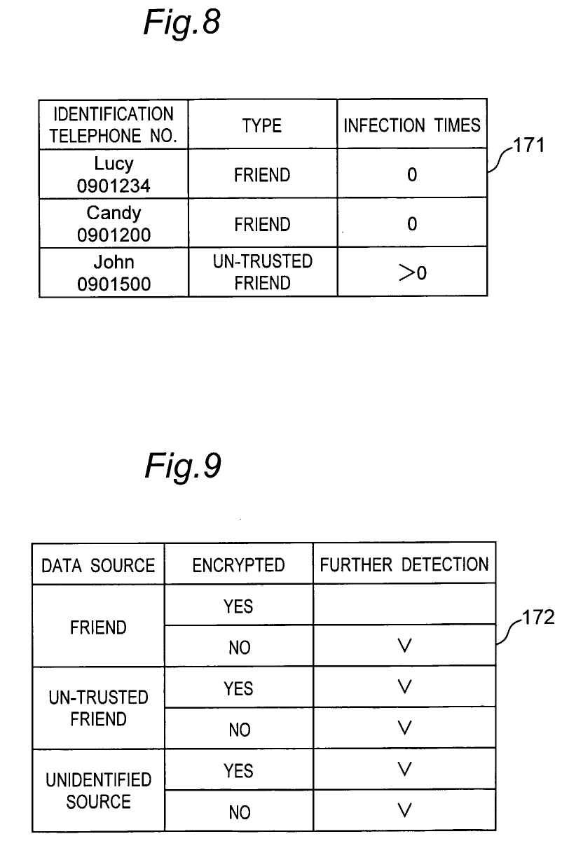

The virus infection information database 11 is used to store computer virus infection record 111 (see FIG. 6) of viruses that recently infected the mobile terminal 1. The virus pattern database 12 is used to record virus pattern data used most recently for detecting whether data received by the mobile terminal 1 is infected by a computer virus, wherein the virus pattern data includes virus information of at least one kind of computer virus that had infected the mobile terminal 1 and at least one kind of computer virus that had infected the network. The transceiver unit 13 is used to send and receive the computer virus infection information and the data. The virus pattern updating unit 14 is used to update the virus pattern data stored in the virus pattern database 12. The virus detecting unit 15 is used to detect whether the data received by the transceiver unit 13 is infected by a computer virus with reference to the virus pattern data stored in the virus pattern database 12. The infection information notifying and storing unit 16 is used to notify the server device 2 that the data received by the transceiver unit 13 is infected by a computer virus with reference to a virus detection result received from the virus detecting unit 15, or to record the computer virus infection information sent from the server device 2 in the virus infection information database 11. The criteria database 17 is used to record criteria 171, 172 (see FIGS. 8 and 9). The criteria inspecting and updating unit 18 is used to determine, with reference to the criteria in the criteria database 17, whether it is necessary to send the data to the server device 2 for further detection of infection by a computer virus when the virus detecting unit 15 did not detect that the data is infected by a computer virus according to the virus pattern data, and to update the criteria in the criteria database 17 according to computer virus infection information received from the virus detecting unit 15 or the server device 2. As for the criteria, details of the same will be described in the succeeding paragraphs with reference to FIGS. 8 and 9.

Referring to FIG. 2, the preferred embodiment of the server device 2, which applies the method for detecting computer viruses of this invention, is used to assist the mobile terminal 1 via the network to detect whether data received via the network is infected by a computer virus. The server device 2 includes a virus infection information database 21, a virus pattern database 22, a statistics unit 23, a ratio determining unit 24, a virus pattern generating unit 25, a transceiver unit 26, and a virus detecting unit 27.

The virus infection information database 21 is used to store computer virus infection record 111 of viruses that recently infected the mobile terminal 1 and computer virus infection record of viruses that recently infected all computers in the network. The virus pattern database 22 is used to record virus pattern data of all computer viruses in the network. The statistics unit 23 is used to make statistics of the computer virus infection record 111 of the mobile terminal 1 and the infection record of all computer viruses in the network as found in the virus infection information database 21 so as to obtain infection number rankings of the viruses that infected the mobile terminal 1 and all computer viruses in the network. The ratio determining unit 24 is used to determine a ratio of a number of kinds of the computer viruses that had infected the mobile terminal 1 to a number of kinds of the computer viruses that had infected the network for subsequent generation of virus pattern data according to the infection number rankings of the viruses that infected the mobile terminal 1 and all computer viruses in the network as determined by the statistics unit 23. The virus pattern generating unit 25 is used to generate the virus pattern data according to the ratio determined by the ratio determining unit 24, wherein the virus pattern data is to be transmitted to the mobile terminal 1 for subsequent use by the mobile terminal 1 in detecting whether the data received via the network is infected by a computer virus. The transceiver unit 26 is used to send and receive the computer virus infection information and the data, and to send the virus pattern data to the mobile terminal 1. The virus detecting unit 27 is used to detect whether data transmitted from the mobile terminal 1 is infected by a computer virus with reference to the virus pattern data of all computer viruses as recorded in the virus pattern database 22, and is used to store the computer virus infection information in the virus infection information database 21.

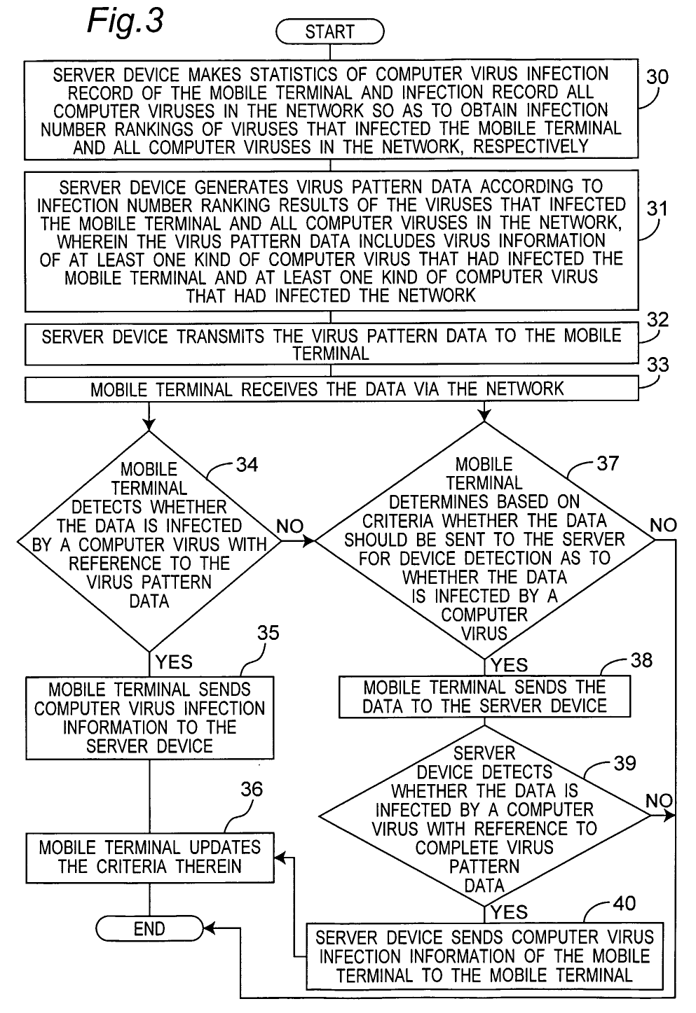

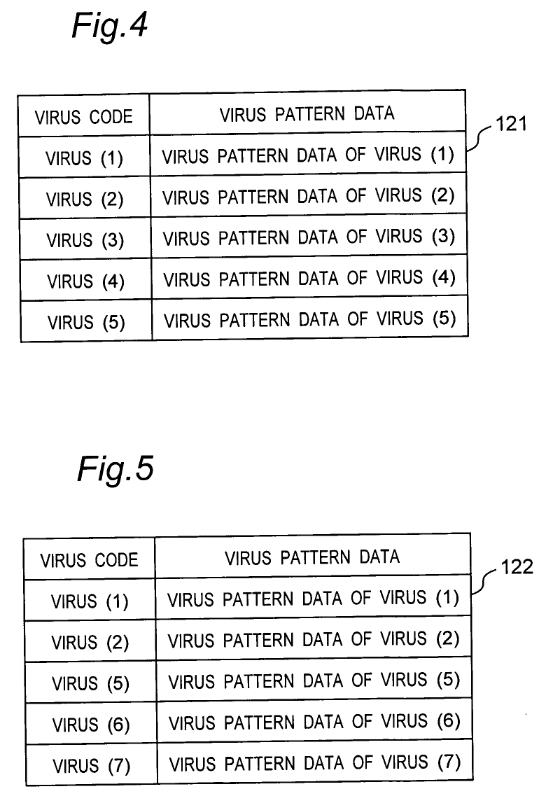

Referring to FIGS. 3, 4 and 6, the method for detecting computer viruses according to this invention is used to detect whether data received by a mobile terminal 1 via a network is infected by a computer virus. It is assumed that virus pattern data 121 is currently recorded in the virus pattern database 12 of the mobile terminal 1. As shown in FIG. 4, the virus pattern data 121 includes virus pattern data of five kinds of viruses, i.e., viruses (1) to (5). Accordingly, the virus detecting unit 15 of the mobile terminal 1 detects whether the data received by the transceiver unit 13 is infected by a computer virus according to the virus pattern data 121. If virus infection of the data was not detected according to the virus pattern data 121, the mobile terminal 1 can send the data to the server device 2 for further detection of virus infection. Assuming that virus infection of the data was detected by the server device 2, the virus infection information of the mobile terminal 1 is not only recorded in the virus infection information database 21 of the server device 2, but is also sent to the mobile terminal 1 for updating the virus infection record 111 in the virus infection information database 11.

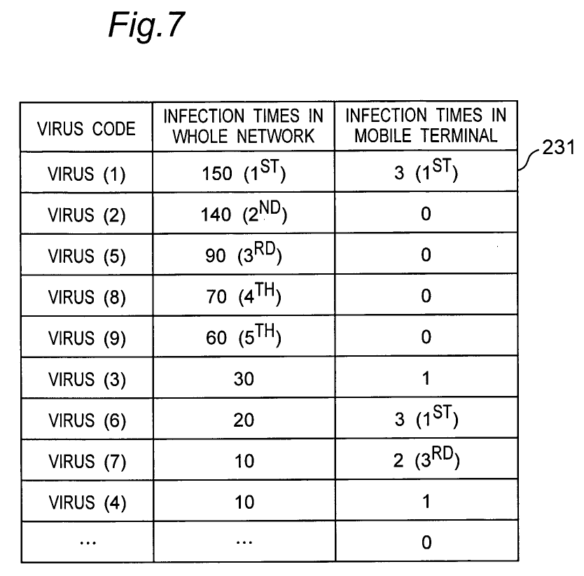

Referring to FIG. 7, the preferred embodiment of the method for detecting computer viruses according to this invention comprises the following steps. First, as shown in step 30, the statistics unit 23 of the server device 2 makes statistics of the computer virus infection record of the mobile terminal 1 and infection record of all computer viruses in the network, respectively, so as to obtain infection number rankings of the viruses that infected the mobile terminal 1 and all computer viruses in the network, respectively. That is, the statistics unit 23 of the server device 2 not only makes a ranking of the virus infection numbers of the mobile terminal 1, but also makes a ranking of infection numbers of all computer viruses in the whole network so to obtain a statistics result 231, as shown in FIG. 7. It is evident from the statistics result 231 that the computer viruses in the top five of the infection number ranking for the whole network are viruses (1), (2), (5), (8) and (9), whereas the computer viruses in the top three of the infection number ranking for the mobile terminal 1 are viruses (1), (6) and (7).

With further reference to FIG. 5, subsequently, as shown in step 31, the server device 2 generates new virus pattern data 122 according to infection number ranking results of the viruses that infected the mobile terminal 1 and all computer viruses in the network, wherein the new virus pattern data 122 includes virus information of at least one kind of computer virus that had infected the mobile terminal 1 and at least one kind of computer virus that had infected the network. It is evident from the statistics result 231 that, since most viruses that infected the mobile terminal 1 are not frequently-infecting viruses of the whole networking environment, in order to detect computer viruses successfully and quickly, this invention uses the ratio determining unit 24 of the server device 2 to determine a ratio of a number of kinds of the computer viruses that had infected the mobile terminal 1 to a number of kinds of the computer viruses that had infected the whole network for subsequent generation of the virus pattern data. For instance, it is assumed herein that the ratio determining unit 24 is used to select five kinds of viruses for the number of kinds of viruses in the new virus pattern data 122, and to set the ratio of the number of kinds of the computer viruses that had infected the mobile terminal 1 to the number of kinds of the computer viruses that had infected the whole network as 3:2. Then, three kinds of the computer viruses that had infected the mobile terminal 1 are selected, i.e., viruses (1), (6) and (7), and two kinds of the computer viruses that had infected the whole networking environment are selected, i.e., viruses (2) and (5), from which the new virus pattern data 122 is generated.

Next, as shown in step 32, the server device 2 uses the transceiver unit 26 to transmit the new virus pattern data 122 to the transceiver unit 13 of the mobile terminal 1 via the network. Subsequently, the transceiver unit 13 of the mobile terminal 1 sends the new virus pattern data 122 to the virus pattern database 12 of the mobile terminal 1 for updating and storing. Then, as shown in step 33, the mobile terminal 1 receives the data from the network through the transceiver unit 13.

Thereafter, as shown in step 34, the virus detecting unit 15 of the mobile terminal 1 detects whether the data received by the transceiver unit 13 is infected by a computer virus with reference to the virus pattern data 122. In the affirmative, the mobile terminal 1 sends computer virus infection information to the server device 2. Then, as shown in step 36, the mobile terminal 1 uses the criteria inspecting and updating unit 18 to update the criteria 171 (see FIG. 8) in the criteria database 17.

With further reference to FIGS. 8, 9 and 10, on the other hand, if the mobile terminal 1 did not detect in step 34 that the data received thereby is infected by a computer virus with reference to the virus pattern data 122, the flow proceeds to step 37, where it is determined with reference to the criteria 171 and 172 shown in FIGS. 8 and 9 whether the data should be sent to the server device 2 for further detection as to whether the data is infected by a computer virus. In the negative, the process of virus detection is ended.

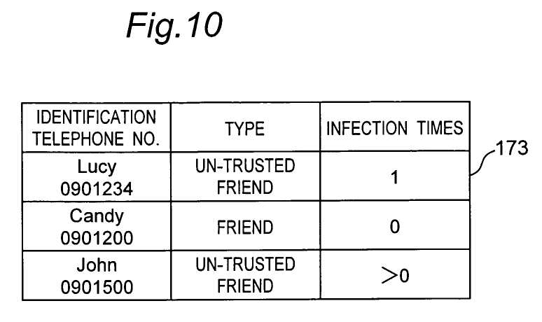

On the other hand, if the data should be sent to the server device 2 to detect if the data is infected by a virus, then, as shown in step 38, the mobile terminal 1 transmits the data to the server device 2. For instance, it is assumed that the data was sent by Lucy and is not encrypted. Based on the criteria 171 and 172, the data should be sent to the server device 2 for further detection if the data is infected by a computer virus. Next, as shown in step 39, the virus detecting unit 27 of the server device 2 detects whether the data is infected by a computer virus with reference to the complete virus pattern data in the virus pattern database 22. If the data is not infected, the process of virus detection is ended. Otherwise, as shown in step 40, the server device 2 sends computer virus infection information of the mobile terminal 1 to the mobile terminal 1. Then, as shown in step 36, since Lucy has sent data infected by a virus, the mobile terminal 1 updates the criteria 171 in the criteria database 17 to the criteria 173 shown in FIG. 10 through the criteria inspecting and updating unit 18, and the process of virus detection is ended.

In sum, the method and applications for detecting computer viruses according to the present invention are not only adapted for accelerating virus detection operations on mobile terminals 1 with limited memory or storage capacity and CPU computing power, but also take into consideration virus infection situations of individual mobile terminals 1 and the whole networking environment at the same time when detecting whether data received by the mobile terminal 1 via a network is infected by a computer virus.

While the present invention has been described in connection with what are considered the most practical and preferred embodiment, it is understood that this invention is not limited to the disclosed embodiment but is intended to cover various arrangements included within the spirit and scope of the broadest interpretation so as to encompass all such modifications and equivalent arrangements.

### INDUSTRIAL APPLICABILITY

The present invention can be applied to a method and an applications for detecting computer viruses.

1. A method for detecting computer viruses, which is adapted for detecting whether data received by a mobile terminal via a network is infected by a computer virus, said method comprising the steps of:
(a) enabling a server device to make statistics of computer virus infection record of the mobile terminal and infection record of all computer viruses in the network, respectively, so as to obtain infection number rankings of viruses that infected the mobile terminal and all computer viruses in the network, respectively;
(b) enabling the server device to generate virus pattern data according to infection number ranking results of the viruses that infected the mobile terminal and all computer viruses in the network;
(c) enabling the server device to transmit the virus pattern data to the mobile terminal via the network;
(d) enabling the mobile terminal to receive the data via the network; and
(e) enabling the mobile terminal to detect whether the data is infected by a computer virus with reference to the virus pattern data, and to transmit computer virus infection information to the server device upon detection that the data is infected by a computer virus.

2. The method for detecting computer viruses as claimed in claim 1, wherein the virus pattern data includes virus information of at least one kind of computer virus that had infected the mobile terminal and at least one kind of computer virus that had infected the network.

3. The method for detecting computer viruses as claimed in claim 1, wherein, if the mobile terminal did not detect that the data is infected by a computer virus according to the virus pattern data in step (e), said method further comprising the following steps after step (e):
(f) enabling the mobile terminal to transmit the data to the server device;
(g) enabling the server device to further detect whether the data is infected by a computer virus with reference to a complete set of virus pattern data therein; and
(h) if the server device detected that the data is infected by a computer virus with reference to the complete set of virus pattern data therein, enabling the server device to transmit computer virus infection information of the mobile terminal to the mobile terminal.

4. The method for detecting computer viruses as claimed in claim 3, further comprising:
prior to step (f), enabling the mobile terminal to determine based on criteria as to whether the data should be sent to the server device for further detection if the data is infected by a computer virus; and
after step (f), enabling the mobile terminal to update the criteria therein.

5. A mobile terminal adapted for detecting, with assistance from a server device, whether data received via a network is infected by a computer virus, said mobile terminal comprising:
a virus infection information database for storing computer virus infection information;
a virus pattern database for recording virus pattern data;
a transceiver unit for sending the computer virus infection information to the server device and for receiving the data via the network;
a virus pattern updating unit for updating the virus pattern data stored in said virus pattern database;
a virus detecting unit for detecting whether the data received by said transceiver unit is infected by a computer virus with reference to the virus pattern data stored in said virus pattern database; and
an infection information notifying and storing unit for notifying the server device that the data received by said transceiver unit is infected by a computer virus according to a virus detection result received from said virus detecting unit, and for recording the computer virus infection information in said virus infection information database.

6. The mobile terminal as claimed in claim 5, wherein the virus pattern data includes virus information of at least one kind of computer virus that had infected the mobile terminal and at least one kind of computer virus that had infected the network.

7. The mobile terminal as claimed in claim 5, wherein said transceiver unit is further used for receiving the computer virus infection information from the server device and for transmitting the data to the server device, said infection information notifying and storing unit being further used for storing the computer virus infection information received from the server device in said virus infection information database, said mobile terminal further comprising:
a criteria database for recording criteria; and
a criteria inspecting and updating unit for determining based on the criteria whether the data should be sent to the server device for further detection if the data is infected by a computer virus when said virus detecting unit did not detect that the data is infected by a computer virus according to the virus pattern data, and for updating the criteria in said criteria database according to the computer virus infection information received from one of said virus detecting unit and the server device.

8. A server device adapted for assisting a mobile terminal via a network to detect whether data received via the network is infected by a computer virus, said server device comprising:
a virus infection information database for storing computer virus infection information of the mobile terminal and infection information of all computer viruses in the network;
a virus pattern database for recording virus pattern data of all computer viruses in the network;
a statistics unit for making statistics of computer virus infection record of the mobile terminal and infection record of all computer viruses in the network as found in said virus infection information database so as to obtain infection number rankings of viruses that infected the mobile terminal and all computer viruses in the network;
a ratio determining unit for determining a ratio of a number of kinds of computer viruses that had infected the mobile terminal to a number of kinds of computer viruses that had infected the network for subsequent generation of virus pattern data according to the infection number rankings of the viruses that infected the mobile terminal and all computer viruses in the network as determined by said statistics unit;
a virus pattern generating unit for generating the virus pattern data according to the ratio determined by said ratio determining unit, wherein the virus pattern data is to be transmitted to the mobile terminal for subsequent use by the mobile terminal in detecting whether the data received via the network is infected by a computer virus;
a transceiver unit for sending and receiving the computer virus infection information and the data, and for sending the virus pattern data to the mobile terminal; and
a virus detecting unit for detecting whether data transmitted from the mobile terminal is infected by a computer virus with reference to the virus pattern data of all computer viruses as recorded in said virus pattern database, and for storing the computer virus infection information in said virus infection information database.

9. The server device as claimed in claim 8, wherein the virus pattern data includes virus information of at least one kind of computer virus that had infected the mobile terminal and at least one kind of computer virus that had infected the network.
